(19) United States
(12) Patent Application Publication
(10) Pub. No.: US 2026/0266582 A1
(43) Pub. Date: Sep. 10, 2026

(54) SYSTEM FOR SUPPORTING A USER OF A HUNTING WEAPON

(71) Applicant: Carl Zeiss AG, Oberkochen (DE)

(72) Inventors: Alexander Tobisch, Oberkochen (DE); Christoph Stark, Oberkochen (DE)

(21) Appl. No.: 19/559,815

(22) Filed: Mar. 6, 2026

(30) Foreign Application Priority Data
Mar. 6, 2025 (DE) 10 2025 108 612.5

(51) Int. Cl. F41G 3/06

(52) U.S. Cl. CPC F41G 3/06

(57) ABSTRACT

A system for supporting a user includes sensors to detect a firing of a shot, to record an orientation and a position of the hunting weapon in space, a device to determine a distance from the hunting weapon to a game animal, a user interface, a display, and a controller configured to detect the firing of the shot, to record the orientation and the position of the hunting weapon at the time of the firing of the shot, to record a shot sign, to determine a shot point region and the distance from the latter to the game animal, to determine a path to the shot point region, to record a stalking sign in the shot point region, and to deduce a lethality of the shot, an at least initial escape route and/or a manifestation of a necessary follow-up search, and to notify the user about the same.

### CROSS REFERENCE TO RELATED APPLICATIONS

This application claims priority to German patent application DE 10 2025 108 612.5, filed Mar. 6, 2025, the entire content of which is incorporated herein by reference.

### TECHNICAL FIELD

The disclosure relates to a system for supporting a user of a hunting weapon, which is intended to be used in particular to facilitate the finding of a shot game animal in the region of the shot point or else during a follow-up search.

### BACKGROUND

When hunting, the situation often occurs that a shot game animal does not die directly at the shot point, but rather flees from the shot point. In connection with finding a shot game animal, the term “shot point” refers to the location of the game animal when it was hit by the projectile of the hunting weapon. Alternatively, but less relevant to the present context, “shot point” is also understood to mean the position of the impact of the projectile in the game animal. If the game animal escapes, a follow-up search is usually necessary. However, this is often not carried out immediately, but rather usually with waiting times of several hours. The background here is, inter alia, that a game animal wounded by having being shot ought not to be startled by the follow-up search and thus continue to flee. Rather, a decrease in adrenaline should be awaited.

The crucial factor in deciding on a follow-up search is observations about the behavior of the game animal upon the placing of the shot (firing of the shot). This is referred to as “shot signs”. Further decision-making bases are so-called “stalking signs”. These are traces in the region of the shot point (blood, game animal flesh, hairs), (animal-track) traces in the ground and the like.

If the terrain is not approximately completely free (e.g., a harvested field), but rather in the region of the shot point, too, offers hiding places, e.g., high grass or grain, but also hilly terrain, finding the shot point is often already hampered. With increasing experience, a hunter is usually able to estimate a shooting distance comparatively accurately, even without electronic aids, and also to locate and find the shot point on the basis of distinctive points in the terrain. However, there is an added factor here in some instances, even for experienced hunters, that once they have left their own shooting position, on account of a changed perspective, the terrain in situ, i.e., at least roughly in the region of the shot point, already looks different and orientation is thus hampered.

### SUMMARY

It is an object of the disclosure to provide assistance to a user of a firearm, in particular a hunting weapon, in finding a shot game animal.

The object is achieved by a system for supporting a user of a hunting weapon as described herein.

The system according to an aspect of the disclosure serves for supporting a user of a hunting weapon (e.g., a hunter), especially in the context of finding and/or making a decision on any follow-up search that may be necessary. For this purpose, the system has first means for recording, in particular in the form of a first sensor for detecting, a firing of a shot from a (the) hunting weapon of the user, a second sensor, which, at least in an intended state of use, is secured to the hunting weapon indirectly or directly and is configured for recording an orientation of the hunting weapon in space, a third sensor for recording a position of the hunting weapon in space, a device for determining a distance from the hunting weapon to a game animal at which the shot is fired, a user interface, at least one display and a controller. The controller is linked, in terms of signal transfer, to the first, second and third sensors and also to the device for determining the distance and the user interface. The controller is additionally configured to detect an indication of the (in particular the effected) firing of the shot with the first means, e.g., with the first sensor.

In accordance with a first aspect of the disclosure, the controller is furthermore configured to detect the orientation of the hunting weapon with the second sensor and the position of the hunting weapon at the time of the firing of the shot or at least at the time of the indication of the firing of the shot with the third sensor. In addition, the controller is configured to determine a shot point region (in particular its location or position in the surroundings and its dimensions), i.e., a region in which the shot point is arranged with a high probability, taking into account at least the orientation and the position of the hunting weapon and the distance from the latter to the game animal. Furthermore, the controller is configured to determine a path to the shot point region and to propose it to the user with the user interface. Typically, in this case, the controller uses principles that are known from the field of (especially hiking) navigation. Optionally, the controller uses a corresponding navigation program.

In accordance with a second aspect of the disclosure, the controller, in addition or as an alternative to the first version described above, is configured to record at least one shot sign corresponding, in particular temporally, to the firing of the shot. In addition, the controller here, too, is configured to determine the shot point region taking into account at least the orientation and the position of the hunting weapon and the distance from the latter to the game animal. Furthermore, the controller is configured to record at least one stalking sign and also the position thereof in the shot point region (i.e., especially if the user with the system according to an aspect of the disclosure is in the shot point region), and on the basis of the at least one shot sign and/or the at least one stalking sign and also the position thereof, in particular in the shot point region, to deduce a lethality of the shot and afterward a manifestation of a possibly necessary follow-up search and to notify the user about same via the user interface.

In accordance with a third aspect of the disclosure, the controller, in addition or as an alternative to the first and/or second version described above, is configured, as already described above, to determine the shot point region taking into account at least the orientation and the position of the hunting weapon and the distance from the latter to the game animal. Furthermore, the controller is configured to record at least one stalking sign and also the position thereof in the shot point region (i.e., especially if the user with the system according to the disclosure is in the shot point region) and/or along a determined, in particular estimated, (at least initial) escape route, and on the basis of the at least one stalking sign and also the position thereof, to estimate an, at least initial, escape route or – in particular in the case where the stalking sign has already been recorded on the escape route – a further course of the escape route and to notify the user about the same via the user interface.

For estimating or determining the at least initial, or proceeding from a along the already estimated, initial escape route, the controller typically uses empirical values. These are, for example, that a game animal that has been hit usually (or at least mostly or with a high probability) typically flees downhill or else into a body of water. The estimation of the escape route is intended here to serve in particular to facilitate commencement of the follow-up search on the part of the user, e.g., a hunter, a person leading the follow-up search, or the like.

The disclosure supports the user of the hunting weapon, i.e., in particular a hunter, advantageously in finding a shot game animal in or near the vicinity of the shot point, so that time can be saved here. The determination of the shot point region in which the shot point is situated with particularly high probability, and also the estimation of the at least initial escape route, contribute to this. Likewise, the disclosure supports the user in deciding what kind (manifestation) of follow-up search is advantageous or recommendable.

For the notification, in particular outputting, of information or other messages via the user interface, the controller typically uses the user interface indirectly, in particular in order to display this information to the user on the display. Further optionally, the user interface is also configured to display an input mask on the display (screen) and to pass on to the controller inputs made on the display (typically a touch-sensitive screen).

Here and hereinafter, the “manifestation of a necessary follow-up search” is under-stood to mean in particular whether a follow-up search is necessary at all (or is not necessary, e.g., on account of a heart shot that led to the death of the game animal at the location of the shot point) and with what intensity the follow-up search is expected to be necessary. Here, tables and/or decision trees are known for different wild animals, and they include stored details about which shot injury can lead to which reactions of the game animal and to which kinds of follow-up searches. While a heart shot usually leads to a so-called death search and a simple degree of difficulty for all game animal species with a short waiting time of up to about 30 minutes, gut shots, e.g., in innards, forelegs or hind legs, in almost all game animal species, may lead to elaborate searches with a long flight, a necessary long waiting time until the follow-up search begins (up to 6 hours) and use of a specially trained tracking dog.

Dimensions of the shot point region depend on the shooting distance (distance between the game animal and the hunting gun) and also on the inclination angle of the hunting gun. This is due to known and/or expected inaccuracies of the individual sensors. In this regard, electronic compass sensors – in particular at least inexpensive ones – sometimes exhibit inaccuracies of up to +/- 5 degrees, which already imposes an inaccuracy on the recording of the shooting direction. Even a position determination with satellite-based positioning systems (also known as GNSS) may exhibit an inaccuracy of several meters. On account of these inaccuracies, the dimensions of the shot point region are advantageously chosen (in particular by the controller) to be larger with increasing distance. In this case, the shot point region is typically chosen in the shape of an ellipse, the long axis of which is oriented transversely to the shooting direction and the short axis of which is oriented in the shooting direction. Alternatively, however, a rectangle can also be chosen. As length and width (i.e., in particular length of the long axis and the length of the short axis as the width), in this case, typically dimensions of approximately (i.e., +/- 1-2 meters) 30 meters and 15 meters, respectively, are chosen for a shooting distance of 100 meters.

Advantageously, the controller is also configured to store the time of the firing of the shot (or at least the indication thereof), the shot point region (i.e., in particular the position thereof, e.g., the coordinates thereof), the shot sign and the respective stalking sign and also the position thereof in an assigned memory for later access. This is advantageous for documentation and/or (if appropriate later) coordination with a specialized person who conducts or leads the follow-up search (“specialist”; also referred to as the “follow-up search leader”).

In order to support the user in the search for the shot point in the shot point region, in accordance with one exemplary embodiment, the controller is configured to display to the user for the shot point region partial regions with varying degrees of probability of finding the shot point with the user interface. In particular, the controller represents these partial regions with different coloring.

Expediently, the controller is also configured to display to the user a search pattern, in particular a search path, through the shot point region with the user interface. This is advantageous inasmuch as the user should carefully and systematically search the shot point region in order not to overlook and/or make unrecognizable any stalking signs, in some instances tiny drops or splashes of blood, which are already difficult to see in grass or on soil after just a short time.

In order to further simplify the user's search for the shot point, in accordance with a further exemplary embodiment, the controller is configured to display the shot point region in a map, typically in a so-called satellite view, on the display and in the process to provide (occupy) parts (regions) of the map with an optical marking, e.g., a veil – in particular a kind of fog. In this case, in accordance with one exemplary embodiment, the controller is configured to provide only regions along a path already taken (and thus in particular searched) by the user to and/or through the shot point region with the marking. For example, the controller is configured to highlight these regions in color, optionally with a colored (e.g., green or yellow) veil. This is intended to make it easier for the user to recognize which regions have already been searched, while the regions that have not yet been searched remain unmarked on the map. Alternatively, however, the controller can also be configured to display the regions of the map which have not yet been walked and thus searched by the user such that they are occupied with the marking, in particular the veil, and to free from the veil only the regions which have already been searched by the user. The veil in the latter case is typically comparable to a “fog of war”, known from computer games, in which the terrain of a (game) map is or becomes visible only when own forces have reconnoitered a corresponding part of the map. In both of the exemplary embodiments, however, the marking or the veil (fog) is typically chosen in such a way that the map and in particular the terrain still remains recognizable through the veil.

In accordance with an exemplary embodiment, the controller is configured to record and store an image recording for the respective stalking sign.

Optionally, in the aforementioned case, the controller is also configured to record an image data flow, in particular by instructing the user to hold a camera in the direction of the ground and to activate a video mode (this last can be omitted if the controller itself has control rights for the camera). The controller can be expediently configured here to perform an analysis of the recorded image data for the presence of stalking signs.

Typically, the controller implements an artificial intelligence which analyzes at least the image recording of one or the respective stalking sign for the purpose of estimating the lethality. The artificial intelligence here can have a decision tree structure. Likewise, however, the artificial intelligence can also be configured as a neural network or the like. An artificial intelligence usually has the advantage of an incomparably shorter calculation time compared with computer-aided calculation methods (in particular simulations). Losses in regard to accuracy can often be accepted and/or are offset by the time advantage. Features of a stalking sign for the estimation of the lethality are, for traces of blood, for example, amount and color (bright red or dark red), drop or splash patterns and the like. Likewise, a stalking sign may also have exit wound evidence, e.g., game animal flesh, hairs and/or bone splinters, which may indicate lethality. Stalking signs and their interpretation are sufficiently known and/or verified with empirical values. Typically, the decision tree structure is based on these empirical values. The neural network is expediently trained with these empirical values and corresponding examples.

Particularly typically, the controller is configured as part of a smart mobile device. In particular, the controller is a processor of the mobile device, which is formed for example by a smartphone, a tablet or by a smartwatch. Typically, however, the smart mobile device also has a camera for recording the image recording. A smartphone or a tablet is therefore appropriate for use here.

The controller is typically formed by a microcontroller with an assigned memory – in the abovementioned exemplary embodiment, therefore, by the microcontroller of the smart mobile device. The functionality described here and hereinafter is installed on this memory by a software application, so that the corresponding functionality is available when the software application is executed.

In accordance with an exemplary embodiment, the system has a module connected or reversibly connectable to a targeting optical unit (in particular a telescopic sight, a night vision or thermal imaging attachment or the like) of the hunting weapon. This module contains at least the second sensor, in particular also the first means (in particular the first sensor) and/or the third sensor, and also a communication interface (or else: data interface) to the controller. In principle, the module can be secured to any targeting optical unit, e.g., with a clip. Typically, however, this module is one which is configured and provided for – in particular reversible – coupling to a mechanical and optionally also electrical interface provided for this purpose at the targeting optical unit. The module constitutes an optional extension of a functional scope of the targeting optical unit. For example, various modules can be arranged alternatively here, e.g., one that serves only for activation and brightness control of a reticle illumination, one that allows distance measurement, and the like. For energy supply purposes, the module can contain a battery cell (primary or secondary) or, especially in the case of the electronic interface to the targeting optical unit (in the intended state of use), can also be connected to an energy supply of the targeting optical unit.

In accordance with a further exemplary embodiment, the controller is assigned at least one interface configured for data retrieval from a database by way of specialists for follow-up searching (“follow-up search leader”), for data exchange with the (in particular the used) specialist for follow-up searching, for data exchange (in particular also for image transfer) with a search drone (which is typically equipped with a thermal imaging device) and/or for data reception at least from location sensors of at least the specialist – typically of all participants who participate in the follow-up search and share their location – and/or a search dog (in particular with a collar with GNSS function). Typically, in this case, the controller is configured to display location information concerning the specialist, the search dog, if appropriate further persons involved in the follow-up search and/or the search drone in a map, in particular also to document said location information and optionally also to share it with the persons. The current location can help to coordinate the follow-up search. A – in particular stored – progression of the respective locations can help to identify gaps in the follow-up search and, if appropriate, to close them. If a further firing of a shot (e.g., a coup de grâce) is necessary during the follow-up search, it is thus easy to check whether safety distances and regions are observed with respect to the persons involved.

For the case of data communication with the search drone, expediently a control for the search drone is also integrated into the controller. This means that the user does not need to switch to a separate application, but rather has all the information together at a glance, e.g., their own location and the location of other persons, and also the position of the search drone and its current image.

In accordance with a further exemplary embodiment, the system has an image sensor coupled to a targeting optical unit of the hunting weapon at least in the intended state of use, said image sensor being configured and provided for recording an image represented by the targeting optical unit upon the firing of the shot. Typically, this image sensor is the - in the case of a digital or electronic targeting optical unit - image sensor present anyway in the targeting optical unit, said image sensor being switched on via a corresponding interface to the controller (and in this state thus forming a part of the system). In accordance with this exemplary embodiment, the controller is configured in particular to determine the shot sign upon the firing of the shot from the image, typically a plurality of successive images (i.e., a video), and from that to estimate, in addition to the lethality, the at least initial escape route, in particular with the aid of map and terrain data. These map and terrain data include in particular civil infrastructure (i.e., roads and buildings, 3D terrain and vegetation).

Optionally, the controller can also be configured to derive the indication of the firing of the shot as well from the plurality of successive images, e.g., by detecting in the images a muzzle flash, smoke, a bullet trajectory, (typical) “traveling” of the hunting weapon or the like.

For estimating the (at least initial) escape route, the controller is typically configured – optionally with a correspondingly trained artificial intelligence – to evaluate stalking signs, in particular positions of a plurality of stalking signs in the terrain (e.g., traces of perspiration, animal tracks), and optionally also image data recorded with the abovementioned image sensor with regard to an escape direction and/or a course of the escape route along the stalking signs found. For example, the controller is configured to link the positions of the stalking signs found in a map to form a course and to extrapolate the latter to an escape route. During extrapolation, the controller also takes into account map and terrain data, e.g., in order to exclude some theoretical escape directions or paths (e.g., through a body of water) and/or to reduce the probability thereof (into an inhabited area).

In accordance with one exemplary embdoiment, the controller is configured to adapt the estimation of the at least initial escape route on the basis of the at least one stalking sign recorded in the shot point region and optionally also on the basis of further stalking signs recorded on an initial region (i.e., along an initial course) of the escape route. If, for example, a trace of perspiration that can be found proceeding from the shot point region deviates from the estimated escape route, the controller can thus constantly adapt the escape route. The estimation of the escape route and also the adaptation thereof are typically carried out by an artificial intelligence. In this case, the controller is also configured to adapt the estimation of the escape route (in particular the further course thereof) additionally on the basis of a recorded course of a route of a search dog (e.g., the tracking dog of the follow-up search leader), on the basis of map and terrain data and/or on the basis of image data (e.g., thermal image data) received from a flying drone, i.e., in particular to continuously estimate it. For the route of the search dog, typically the latter’s collar with GNSS function, i.e., in particular location data of the search dog, is used. In addition, the controller also takes into account map and terrain data, e.g., in order to exclude some escape paths (e.g., through a body of water) and/or to reduce the probability thereof (into an inhabited area). Image data from a flying drone can likewise be used here, for example in order to include current obstacles (e.g., flood water) in the terrain data.

The controller is expediently configured to give notification of such an adapted estimation of the escape route – i.e., the adapted further course thereof – via the user interface, e.g., to present it on the map displayed on the display.

Expediently, the controller is configured to propose (display) different specialists on the basis of the assessment concerning the lethality of the shot and optionally also the at least initial escape route and also depending on a qualification of the specialists noted in the database for the follow-up search. If, for example, a (presumable) heart shot and an initial escape route in the direction of open woodland make it possible to assume a simple follow-up search without a specially trained tracking dog, e.g., only a specialist with a “normally” trained hunting dog is displayed. On the other hand, in the event of a shot into a leg and an initial escape route in the direction of thick forest, the controller proposes a specialist with a specially trained tracking dog, since a lengthy follow-up search is to be assumed here. In addition, the controller also indicates waiting times which from experience are necessary until the follow-up search begins.

In principle, the means for recording the indication of the firing of the shot, besides or as an alternative to the optical recording described above, can also be formed by the user interface, in which the user inputs information that they have fired the shot. It is typical, however, for the first means to be formed by a first sensor for detecting the firing of the shot, typically by an acceleration sensor and/or a microphone. Typically, the first sensor is additionally integrated into the module described above. In the latter case, the first sensor is thus arranged particularly close to the firing of the shot, and in the case of the acceleration sensor an approximately direct recording of the recoil is thus made possible. Advantageously, the acceleration sensor, in particular in the form of a 3D micro-electro-mechanical systems (MEMS) acceleration sensor or as an inertial measurement system in the form of a MEMS, can also form or have the second sensor for recording the orientation of the hunting weapon. Such an acceleration sensor or such an inertial measurement system can, as known, e.g., from smartphones, also be used as a gyroscopic sensor. On the other hand, the use of the microphone for recording the shot has the advantage that a sampling rate can be kept comparatively low, because the acoustic image of the shot is longer-lasting in comparison with the acceleration upon the firing of the shot that forms the recoil, and can thus be detected sufficiently accurately even with a lower sampling rate. The microphone also need not be integrated into the module, but rather can in principle be a microphone of the smartphone that provides the controller.

Especially in the event of the follow-up search, the controller is also configured to take into account boundaries of a hunting area currently being used, e.g., to retrieve them from a corresponding database, and to document if the game animal during escape and/or the “follow-up search team” (i.e., the follow-up search leader and the search dog, optionally also further persons involved) crosses area boundaries. Optionally, the controller also uses image data from the flying drone for documentation purposes.

The system described above allows not only the simplified finding of the shot point but also the possibility of supporting the follow-up search and/or the planning thereof. In this case, the system also has high compactness on account of the integration possibilities described; in particular, an additional device separate from hunting gun and smartphone can advantageously be omitted when the module described above is used.

Here and hereinafter, the conjunction “and/or” should be understood to mean in particular that the features linked by this conjunction can be embodied both jointly and as alternatives relative to one another.

### BRIEF DESCRIPTION OF THE DRAWINGS

The disclosure will now be described with reference to the drawings wherein:

FIG. 1 shows, in a basic schematic illustration, a system for supporting a user,

FIGS. 2 to 5 show various exemplary embodiments of the system in each case in perspective and detail-related illustration, and

FIGS. 6 and 7 show, in each case in a basic schematic illustration, a smartphone with an application at two different times and uses within the application.

### DESCRIPTION OF EXEMPLARY EMBODIMENTS

Mutually corresponding parts are provided with the same reference signs throughout the figures.

FIG. 1 schematically shows a system 1 for supporting a user. In the present exemplary embodiment, the system 1 has a module 2, which, in a manner described in more specific detail below, is secured to a targeting optical unit, here specifically a telescopic sight 4, for a firearm, or is integrated into the telescopic sight 4. Furthermore, the system 1 also has a controller 6, which in the present exemplary embodiment is formed by a microprocessor of a smart mobile device, here a smartphone 7. In this case, the smartphone 7 also has a user interface 8 for the user to the system 1 and a display 9.

The telescopic sight 4 has a tubular (outer) housing 10, in which a plurality of lenses 12 are arranged successively along a light path 14. In this case, the lenses 12 form at least one objective lens group 16 and a lens group of a so-called erecting system 18, which is arranged in an “inner tube” 20, i.e. a tubular holder, on the image side following the objective lens group in the housing 10. A further lens group, which forms an eyepiece 22, is arranged in the housing 10 on the image side following this erecting system 18. In the illustrated exemplary embodiment, a reticle element 24 is arranged on the eyepiece-side end of the inner tube 20. This reticle element 24 is formed for example by a glass pane bearing a reticle marking printed, etched or otherwise made visible thereon. This reticle marking brings about a reticle (usually a kind of crosshair or the like) in an image visible through the eyepiece 22. The housing 10 carries an adjustment turret 26 including an adjustment mechanism (not illustrated in more specific detail), which in the present exemplary embodiment acts on the inner tube 20 and, upon actuation, tilts the erecting system 10 relative to the light path 14. The reticle element 24 is arranged on the image-side end of the erecting system 18 at the pivot point of the inner tube 20, such that the reticle element 24 itself remains virtually stationary. A relative adjustment of the reticle in the image that can be viewed by a user (shooter, user) is brought about by the tilting of the erecting system 18.

In an alternative exemplary embodiment, not illustrated, the reticle element 24 is arranged between the objective lens group and the erecting system 18. In this case, the adjustment mechanism acts on the reticle element 24 and offsets it relative to the light path 14 of the objective lens group.

As is evident from FIG. 1, the module 2 is arranged at the objective side on the exterior of the housing 10 of the telescopic sight 4.

The module 2 has means for detecting a firing of a shot, here in the form of a first sensor 30, which is configured to detect the firing of the shot from a hunting weapon (firearm, hunting rifle) on which the telescopic sight 4 is mounted. In addition, the module 2 has a second sensor 31, which is configured to record a spatial orientation of the firearm, specifically an inclination angle (elevation angle), a yaw angle (swivel angle) and a roll angle. In addition, the module 2 also includes a device for distance measurement (“rangefinder 33”). Furthermore, the module 2 has a data interface 32 for communication with the controller 6, specifically via a corresponding, wireless interface 34 of the smartphone 7. For example, the (data) communication here takes place by way of the Bluetooth standard. The smartphone 7 additionally has a further interface, referred to here as Internet interface 36, which is configured for wireless data connection to the Internet, specifically to websites and/or servers. Furthermore, the smartphone 7 also has a sensor (third sensor 38) for determining the location of the firearm.

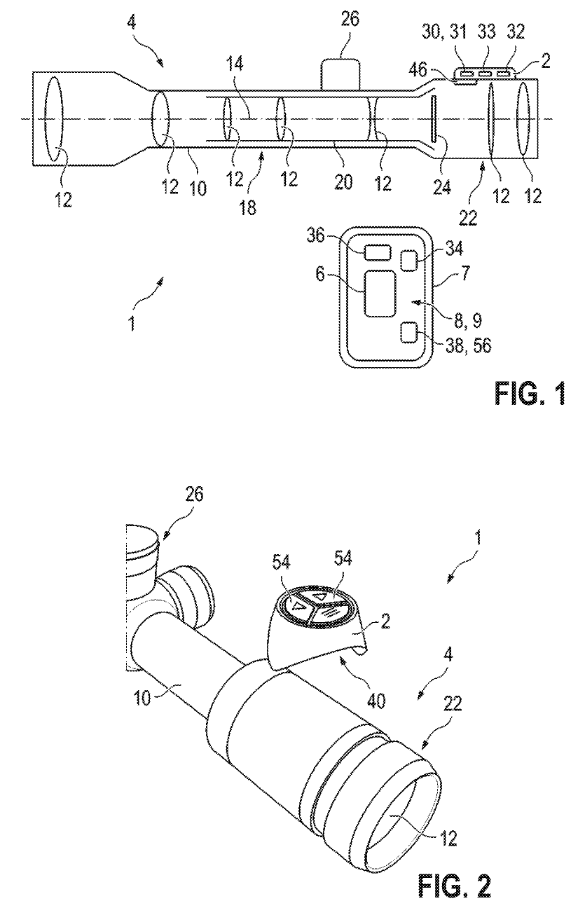

FIGS. 2 to 5 show variants of how the module 2 can be secured to the telescopic sight 4. FIG. 2 describes an exemplary embodiment in which the module 2 can be retrospectively mounted on any telescopic sight 4. The module 2 has a round recess 40 on the bottom side, by which the module 2 can be placed onto the housing 10 of the telescopic sight 4. The securing is effected here with a clip or else with a rubber band, in a manner comparable to the securing of bicycle lights to the frame or handlebars. In this case, there is no coupling to the telescopic sight 4 in terms of signal transfer.

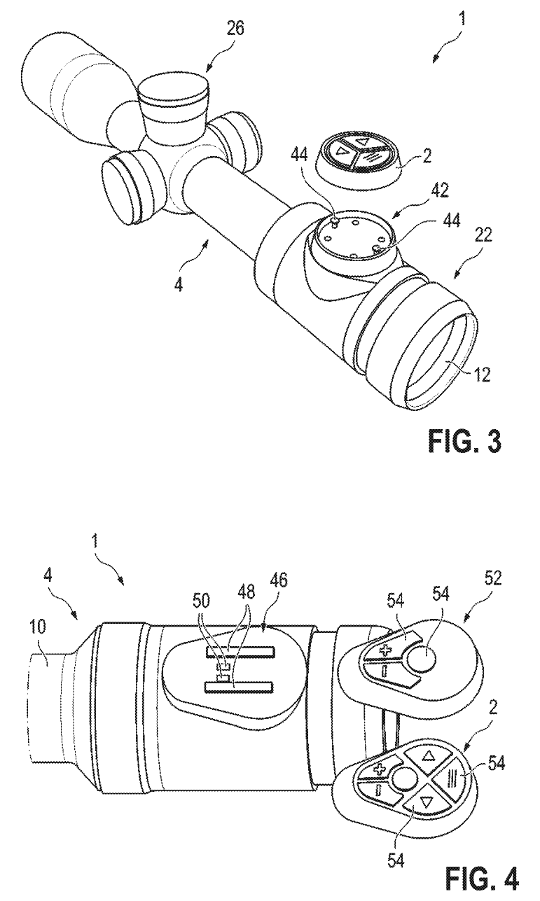

FIGS. 3 and 4 illustrate variants in which a mechanical coupling, and also a coupling in terms of signal transfer, between the telescopic sight 4 and the module 2 can be reversibly produced. In FIG. 3, a circular receptacle 42, similar to an adjustment turret, is formed on the housing 10 of the telescopic sight 4. The receptacle 42 is configured to hold the system module 31 with a kind of bayonet connection. That is to say that the module 2 is placed onto the receptacle 42 and rotated by approx. 20-30 degrees. FIG. 3 reveals two flat head pins 44 in the receptacle 42, which engage into corresponding openings in the module 2 and engage behind same in the course of the rotation. A galvanic connection to corresponding, electrically controllable elements of the telescopic sight 4 can also be formed via these pins 44, e.g., for the purpose of reticle illumination 46 (see FIG. 1).

FIG. 4 illustrates a kind of dovetail receptacle 46 for the module 2. This dovetail receptacle 46 has two parallel rails 48 with (in particular each facing away from one another) undercuts onto which it is possible to push the module 2 with diametrically opposed rails or grooves (none of which is illustrated in more specific detail). In addition, two contact surfaces 50 are formed on the dovetail receptacle 46, and are contacted with corresponding spring contacts (not illustrated in more specific detail) of the module 2 in the intended mounting position. FIG. 4 also illustrates a second module 52, which can be secured to the telescopic sight 4 instead of the module 2. For example, this module 52 forms a different functional scope, e.g., just one setting option for the reticle illumination 46.

With the contact surfaces 50, control signals output by the controller 6 can be received in the telescopic sight 4 and can be used, e.g., to change a luminous color of the reticle element 24.

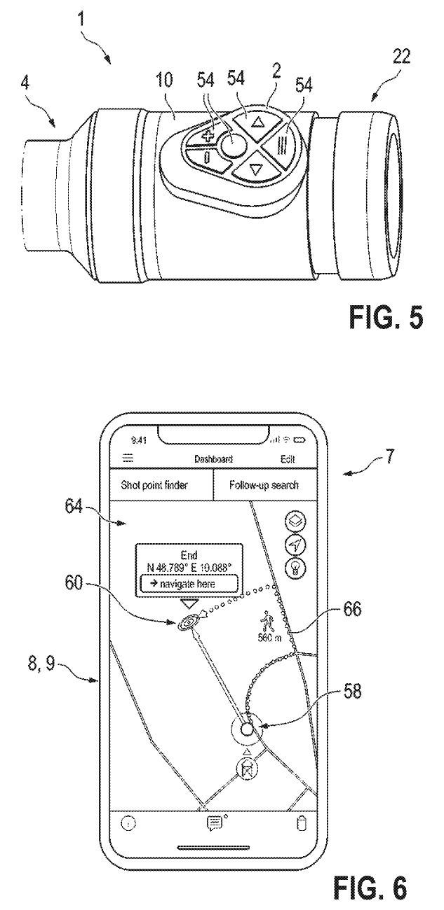

FIG. 5 illustrates an exemplary embodiment in which the module 2 is integrated into the telescopic sight 4. Although the module 2 is accessible from a top side of the telescopic sight 4, it is not detachable from the latter. In the exemplary embodiments in accordance with FIGS. 2 to 4, the module 2 has its own, assigned energy source, e.g., a button cell (not illustrated).

As can be gathered from FIGS. 2 to 5, the module 2 has one or else a plurality of buttons 54 on a top side in order to activate the module 2, deactivate it and/or optionally select different functions.

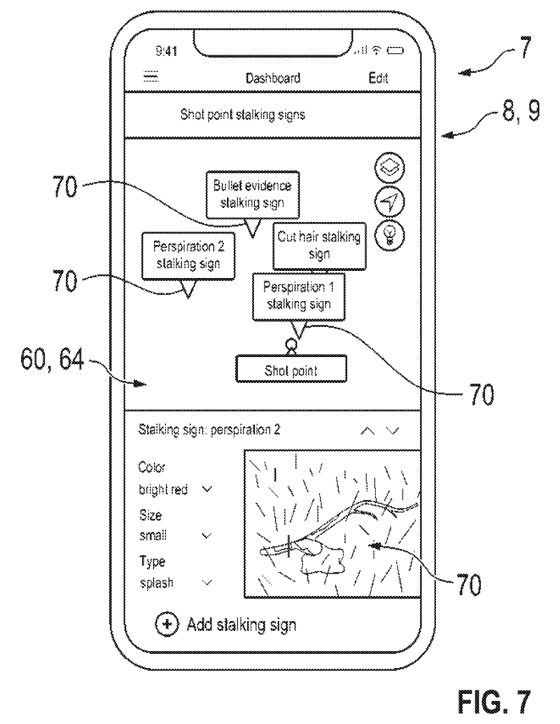

Functionalities of the system 1 are described in more specific detail below, in particular with reference to FIGS. 6 and 7. When hunting, the user firstly activates on the smartphone 7 an (software) application installed so as to be executable on the controller 6, also referred to as “hunting app”. The controller6 thereupon connects to the module 2 and “waits” for a firing of a shot by the user. Specifically, the controller 6 obtains the data (signals) from the first sensor 30 via the (data) interfaces 32 and 34 and evaluates them continuously. The first sensor 30 is formed by a multi-axis, specifically a nine-axis, motion sensor. In this case, the controller 6 deduces the firing of the shot if a correspondingly high acceleration value, in particular for a plane in which the hunting rifle is oriented, is recognizable from the sensor signal.

In this exemplary embodiment, the first sensor 30 also includes the second sensor 31 for recording the orientation of the hunting rifle, because such a nine-axis motion sensor usually contains a three-dimensionally measuring acceleration sensor, and also a gyroscopic sensor and a magnetometer (also: compass sensor) and can thus also be used to recognize at least changes in the spatial orientation, but also – especially taking into account the acceleration due to gravity and the cardinal point – to determine an absolute orientation. The controller 6 thus also determines the spatial orientation of the hunting rifle for the time of the firing of the shot, which orientation is recognized as corresponding to a starting trajectory of the projectile fired by the hunting rifle. This starting trajectory can be used as a basis to calculate the trajectory of the projectile.

In addition, the controller 6 determines, with the rangefinder 33, a distance between the hunting rifle and a game animal which the user has identified and shot. Furthermore, the controller 6 determines, with the third sensor 38, here a GNSS sensor 56 of the smartphone 7, the current own position 58 (in particular the coordinates) and thus also the position of the hunting rifle (see FIG. 6).

The telescopic sight 4 has an image sensor (not illustrated) for recording image data. Optionally, this image sensor can be integrated into an attachment (or a downstream device) for the telescopic sight 4. The module 2 is connected to the image sensor in terms of data transfer. In this case, the controller 6 records a shot sign that is temporally associated with the firing of the shot. At customary hunting distances in the range of up to 150 meters, rarely more than 200 meters, a projectile flight time of less than 1.5 seconds should be assumed, so that a reaction (the shot sign) of the game animal to the shooting, specifically to the impact of the projectile, in the range of up to 3 seconds after the firing of the shot should be expected. Within this period, a shot sign should in any case be understood as being temporally associated with the firing of the shot. Shot sign in the present case is interpreted as a visually recognizable shot sign, in particular a behavior of the game animal summarized under the term “signing”, and the image data supplied by the image sensor are thereupon evaluated in respect thereof. The controller 6 uses an artificial intelligence to deduce the position of the hit and the type of hit from the shot sign. In the event of a heart hit, red deer usually rear up, and in the event of a hit on the dorsal vertebrae (especially the spinous processes; so-called spine shot), red deer usually collapse immediately, but rise again after a short time. Corresponding behavior for other kinds of hit and wild animal species is applicably well known.

The controller 6 firstly determines a position of the shot point in the terrain on the basis of the distance to the game animal and the orientation of the hunting rifle and places a “shot point region 60” around the determined position of the shot point on account of expected inaccuracies. For example, an ellipse having a short axis of 15 meters and a long axis of 30 meters at a shooting distance of 100 meters on the plain is chosen as the dimensions of the shot point region 60. The long axis is chosen in particular transversely with respect to the shooting direction. The controller 6 shows the own position 58 and the shot point region 60 on the display 9 of the smartphone 7 in a map representation 64. Furthermore, the controller 6 determines a path 66 to the shot point region 60 which is easy for the user, for example leading along existing field paths. The controller 6 additionally encodes the shot point region 60 in color depending on a probability of finding, in the present example red for an increased probability of finding, the game animal or the shot point.

Once the user has reached the shot point region 60, the controller 6 specifies a search path through the shot point region 60 in order to enable the most effective search possible in the shot point region 60.

On the basis of the shot sign, the controller 6 (with artificial intelligence) additionally estimates a lethality of the shot in order to be able to make an assessment as early as possible about a possibly necessary follow-up search, in particular the manifestation thereof (e.g., simple death search owing to heart shot, simple search on account of a corresponding hit position, or complicated search with a specially trained tracking dog). This assessment is influenced – optionally subsequently or continuously – by further information found. In this regard, the controller 6 prompts the user to take at least photographs (image recordings) of found stalking signs 70 with the smartphone 7. The controller 6 evaluates these photographs with artificial intelligence (image recognition with regard to the type of blood traces and comparison with trained data with regard to typical stalking signs for specific hit positions) and passes on this information to the user, specifically via the display 9 (cf. FIG. 7).

On the basis of the stalking signs 70, but also on the basis of the shot sign, the controller 6 deduces an at least initial escape route of the game animal. In this case, the controller 6 also takes into account terrain features such as woodland, civil infrastructure, hiding places, etc. The controller 6 likewise outputs this escape route via the display 9. Furthermore, via the Internet interface 36, the controller 6 accesses a database with specialists (follow-up search leaders and/or search dog handlers) stored for the surroundings of the present hunting area. If additional qualifications are stored for these specialists, e.g., one of the specialists has only a “normal” hunting dog, but another has a particularly qualified (trained) tracking dog, the controller 6 takes this into account for a proposal. If the controller 6 has ascertained, e.g., that the shot only hit a leg of the game animal and a particularly lengthy follow-up search is therefore necessary, the controller 6 proposes, e.g., only specialists with correspondingly qualified tracking dogs. Optionally, the controller 6, in response to a corresponding activation by the user, may contact one of the proposed specialists, in particular a specialist chosen by the user, and send them the determined data in advance, if appropriate. For this purpose, the controller 6 stores these data, at least a time of the firing of the shot, the shot point region 60 (in particular the position thereof), the recorded shot sign and also the stalking signs 70 with their respective position for later retrieval by the specialist or the user themself in an assigned memory.

In a manner not illustrated in more specific detail, a drone control for a drone, e.g., with thermal imaging device, is additionally integrated into the controller 6, and can be used for the follow-up search. This enables a drone image to be inserted in addition to a map view displaying the estimated escape route.

The hunting app can also establish a connection to several users or persons, e.g., the specialist or further helpers involved in the follow-up search, so that the determined data can also be made available to (shared with) the specialist.

The controller 6 is expediently also configured to continuously adapt the escape route during the follow-up search. For this purpose, the controller 6 evaluates in particular further found stalking signs, a search route typically recorded with a GNSS collar of a search dog, (thermal) image data of the drone possibly used, in order, e.g., to compare deviations of the search route of the search dog from the estimated escape route and to estimate from that the further course of the escape route. For example, in this case, the controller 6 also takes into account terrain and map data, in order, e.g., to use a course of a river as an insurmountable obstacle for the shot game animal on the escape route. In this case, the controller 6 can also document and/or display if the game animal or the search dog crosses an area boundary. In this case, it is often necessary to consult with the owner or manager of the neighboring hunting area.

Likewise, the controller 6 is configured, in particular via the hunting app, to record location data of the persons involved in the follow-up search and also in turn to share these data with these persons – typically with this application – so that all persons involved know where other persons are located. Optionally, this application can also be used to obtain information about locations of other persons who are not involved but who are logged into the application. This contributes to increased safety, e.g., if a coup de grâce is necessary.

The subject matter of the disclosure is not restricted to the exemplary embodiments described above. Rather, further embodiments of the disclosure can be derived from the above description by a person skilled in the art. In particular, the individual features of the disclosure described with reference to the various exemplary embodiments, and the design variants thereof, can also be combined with one another in a different way.

### LIST OF REFERENCE NUMERALS

1 System

2 Module

4 Telescopic sight

6 Controller

7 Smartphone

8 User interface

9 Display

10 Housing

12 Lens

14 Light path

18 Erecting system

20 Inner tube

22 Eyepiece

24 Reticle element

26 Adjustment turret

30 First sensor

31 Second sensor

32 Data interface

34 Interface

36 Internet interface

38 Third sensor

40 Recess

42 Receptacle

44 Pin

46 Dovetail receptacle

48 Rail

50 Contact surface

52 Module

54 Button

56 GNSS sensor

58 Position

60 Shot point region

64 Map representation

66 Path

70 Stalking sign

What is claimed is:

1. A system for supporting a user of a hunting weapon, the system comprising:
first means for recording a firing of a shot from the hunting weapon;
a second sensor, which, at least in an intended state of use, is secured to the hunting weapon indirectly or directly and which is configured to record an orientation of the hunting weapon in space;
a third sensor configured to record a position of the hunting weapon in space;
a device configured to determine a distance from the hunting weapon to a game animal at which the shot is fired;
a user interface;
at least one display; and
a controller linked, in terms of signal transfer, to the first means, to the second and third sensors, to the device configured to determine the distance, and to the user interface, wherein the controller is configured to:
record an indication of the firing of the shot with the first means,
record the orientation of the hunting weapon with the second sensor and the position of the hunting weapon at a time of the firing of the shot or at least at the time of the indication of the firing of the shot with the third sensor,
determine a shot point region taking into account at least the orientation and the position of the hunting weapon and the distance from the hunting weapon to the game animal, and
determine a path to the shot point region and propose the path to the shot point region to the user with the user interface.

2. The system as claimed in claim 1, the system comprising:
the first means for recording a firing of a shot from the hunting weapon;
the second sensor, which, at least in the intended state of use, is secured to the hunting weapon indirectly or directly and which is configured to record an orientation of the hunting weapon in space;
the third sensor configured to record a position of the hunting weapon in space;
the device configured to determine the distance from the hunting weapon to the game animal at which the shot is fired;
the user interface;
the at least one display; and
the controller linked, in terms of signal transfer, to the first means, to the second and third sensors, to the device configured to determine the distance, and to the user interface, wherein the controller is further configured to:
record an indication of the firing of the shot with the first means,
temporally record at least one shot sign corresponding to the firing of the shot,
determine a shot point region taking into account at least the orientation and the position of the hunting weapon and the distance from hunting weapon to the game animal,
record at least one stalking sign and the position of the stalking sign in the shot point region,
based on the at least one shot sign and/or the at least one stalking sign and the position of the at least one shot sign and/or of the at least one stalking sign in the shot point region, deduce a lethality of the shot and subsequently a manifestation of a possibly necessary follow-up search, and notify the user about the lethality and the manifestation via the user interface.

3. The system as claimed in claim 1, the system comprising:
the first means for recording a firing of a shot from the hunting weapon;
the second sensor, which, at least in the intended state of use, is secured to the hunting weapon indirectly or directly and which is configured for recording an orientation of the hunting weapon in space;
the third sensor for recording a position of the hunting weapon in space;
the device configured to determine the distance from the hunting weapon to a game animal at which the shot is fired;
the user interface;
the at least one display; and
the controller linked, in terms of signal transfer, to the first means, to the second and third sensors, and to the device configured to determine the distance and the user interface, wherein the controller is further configured to:
to record an indication of the firing of the shot with the first means,
record the orientation of the hunting weapon with the second sensor and the position of the hunting weapon at the time of the firing of the shot with the third sensor,
determine a shot point region based on at least the orientation and the position of the hunting weapon and the distance from the shot point region to the game animal,
record at least one stalking sign and the position of the stalking sign in the shot point region and/or along a determined escape route,
based on the at least one stalking sign and the position of the at least one stalking sign, estimate an escape route or the further course of the escape route and notify the user about the escape route or the further course of the escape route via the user interface.

4. The system as claimed in claim 1, wherein the controller is further configured to:
display to the user for the shot point region partial regions with varying degrees of probability of finding the shot point with the user interface, and
display to the user a search pattern through the shot point region with the user interface.

5. The system as claimed in claim 1, wherein the controller is further configured to:
display the shot point region in a map on the display, and in a process to provide regions of the map or regions along a path already taken by the user to and/or through the shot point region, with an optical marking.

6. The system as claimed in claim 2, wherein the controller is further configured to record and store an image recording for the respective stalking sign.

7. The system as claimed in claim 6, wherein the controller implements an artificial intelligence which analyzes at least the image recording of the respective stalking sign to estimate the lethality.

8. The system as claimed in claim 1, wherein the controller is included in a smart mobile device, and
wherein the smart mobile device has a camera for recording an image recording.

9. The system as claimed in claim 1, further comprising:
a module connected or reversibly connectable to a targeting optical unit of the hunting weapon, the module containing at least one of the second sensor, the first means, and the third sensor, and a communication interface to the controller.

10. The system as claimed in claim 2, wherein the controller is assigned at least one interface configured for data retrieval from a database by way of specialists for follow-up searching, for data exchange with the specialists for follow-up searching, for data exchange with a search drone and/or for data reception at least from location sensors of at least the specialists and/or a search dog, and
wherein the controller is configured to display location information concerning the specialists, the search dog, and/or the search drone in a map and to document the location information.

11. The system as claimed in claim 10, wherein a control for the search drone is integrated into the controller.

12. The system as claimed in claim 3, further comprising:
an image sensor coupled to a targeting optical unit of the hunting weapon at least in the intended state of use and serving for recording an image represented by the targeting optical unit upon the firing of the shot,
wherein the controller is further configured to:
determine at least one shot sign upon the firing of the shot from a plurality of successive images, and
estimate at least initial escape route based on map and terrain data.

13. The system as claimed in claim 12, wherein the controller is further configured to adapt the estimation of the at least initial escape route and to communicate the estimate via the user interface based on at least one of:
the at least one stalking sign recorded in the shot point region,
further stalking signs recorded along the escape route,
a recorded course of a route of a search dog,
map and terrain data, and
image data received from a flying drone.

14. The system as claimed in claim 2, wherein the controller is further configured to:
record location data of persons involved in the follow-up search, and
share the location data for the persons.

15. The system as claimed in claim 9, wherein the first means are formed by at least one of an acceleration sensor and a microphone, and
wherein the first means are integrated into the module .
